(19) United States
(12) Patent Application Publication
(10) Pub. No.: US 2001/0042392 A1
(43) Pub. Date: Nov. 22, 2001

(54) Key with metallic stem and plastic casing comprising a locking housing

(76) Inventor: Cyril Meynier, Varennes Vauzelles (FR)

Correspondence Address: Liniak, Berenato, Longacre & White, Suite 240, 6550 Rock Spring Drive, Bethesda, MD, 20817, US

(21) Appl. No.: 09/842,677

(22) Filed: Apr. 27, 2001

(30) Foreign Application Priority Data
May 9, 2000 (FR) 0005871

(51) Int. Cl. E05B 19/04

(52) U.S. Cl. 70/408

(57) ABSTRACT

The key designed to mechanically actuate a lock comprises a metallic stem (1) with a longitudinal axis (2) and a plastic casing (3) rigidly connected to one end of the said stem. The casing of this key consists of a lower half casing (4) connected to the stem by a link (5) free to slide along the said longitudinal axis and an upper half casing (6) that is rigidly connected to the lower half casing and that comprises a post (7) perpendicular to the longitudinal axis that fits into a corresponding hole in the said stem to prevent any translation movement between the stem and the casing along the said longitudinal axis. With this layout, the lower half casing alone resists the torsion torque applied to the casing by the stem when a lock is being opened, without the addition of any other connecting part between the stem and the lower half casing, which significantly reduces the manufacturing cost of such a key and avoids the use of any visible part that could modify the style and appearance of the key.

The invention relates to a key designed to mechanically actuate a lock, comprising a metallic stem with a longitudinal axis, and a plastic casing rigidly connected to one end of the said stem.

This type of key is well known in the automotive industry in which keys with a built-in remote control are more and more frequently used, that the user can use to unlock his vehicle simply by pressing on the plastic casing of his key to emit an infrared signal towards his or her vehicle. With this type of key, the electronic remote control circuit is usually located in a plastic casing, such that the remaining space for the mechanical link between the stem and the casing is very small. Thus, it is difficult to make a rigid and reliable assembly at low cost.

Conventionally, the plastic casing for this type of key is composed of two complementary half casings inside which the stem is trapped like in a sandwich. These half casings are usually symmetrical and complementary, and work together to block the stem. The weakness of this type of assembly is that it does not have a good resistance to the torsion torque applied to the casing by the stem as the lock is opened. Eventually, this torsion torque tends to open up the two half casings making the key unusable. One manner of solving this problem is to screw the stem onto one of the half casings, thus the entire torsion torque is resisted by only one of the half casings such that there is no tendency for one half to separate from the other. The weakness of this solution is that it makes the key manufacturing procedure more complicated and therefore increases the manufacturing cost.

The purpose of the invention is to overcome these disadvantages.

Consequently, the purpose of the invention is a key intended to mechanically activate a lock, comprising a metallic stem with a longitudinal axis, and a plastic casing rigidly connected to one end of the said stem, characterized in that the said casing includes a lower half casing connected to the stem by a link free to slide along the said longitudinal axis and an upper half casing that is rigidly connected to the lower half casing and that comprises a post perpendicular to the longitudinal axis that fits into a corresponding hole in the said stem to prevent any translation movement between the stem and the casing along the said longitudinal axis.

With this type of construction, the lower half casing resists most of the forces applied to it by the stem, and particularly the torsion torque that occurs when a lock is opened, without the addition of a screw or any additional part, in order to reduce the manufacturing cost of such a key.

According to a particular embodiment of the device according to the invention, the mechanical link between the stem and the lower half casing fixes five of the six degrees of freedom, the only remaining degree of freedom being translation of the stem with respect to the casing along the longitudinal axis. In this manner, all forces applied by the stem to the casing, except for a tearout force along the longitudinal axis, are resisted by the lower half casing alone. A post in the upper half casing fits into a corresponding hole in the end of the stem to prevent the said translation along the longitudinal axis and resist the said tear force.

According to another particular embodiment of the key in which the upper half casing is clipped onto the lower half casing, the result is a key with an even lower manufacturing cost.

According to another particular embodiment of the key, the post in the upper half casing is in the form of a cross to facilitate its insertion into the corresponding hole at the end of the stem and to simplify the manufacturing process for the said upper half casing that can be achieved by molding.

According to another embodiment, the upper half casing comprises two plates that are parallel to the post and parallel to the longitudinal axis and that are inserted in corresponding lateral recesses in the stem to work in cooperation with the post in resisting the tearout forces applied by the stem to the casing along the longitudinal axis.

The invention will now be described in more detail with reference to the attached drawings that illustrate one embodiment of the invention as a non-restrictive example.

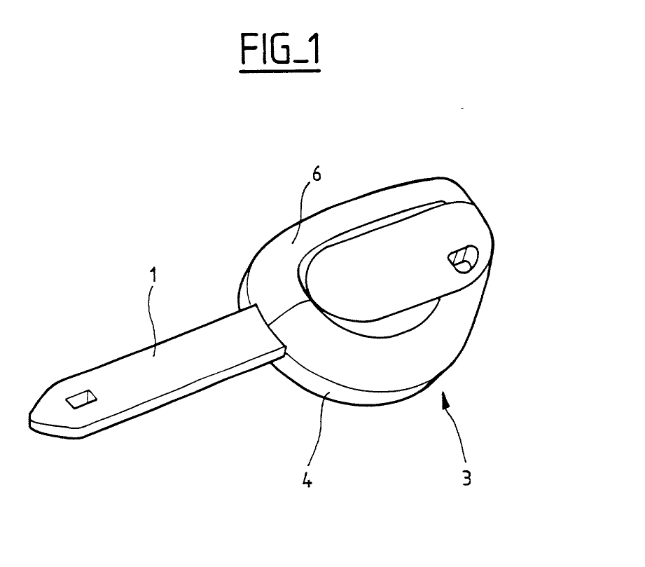

FIG. 1 is an overview of the assembled key.

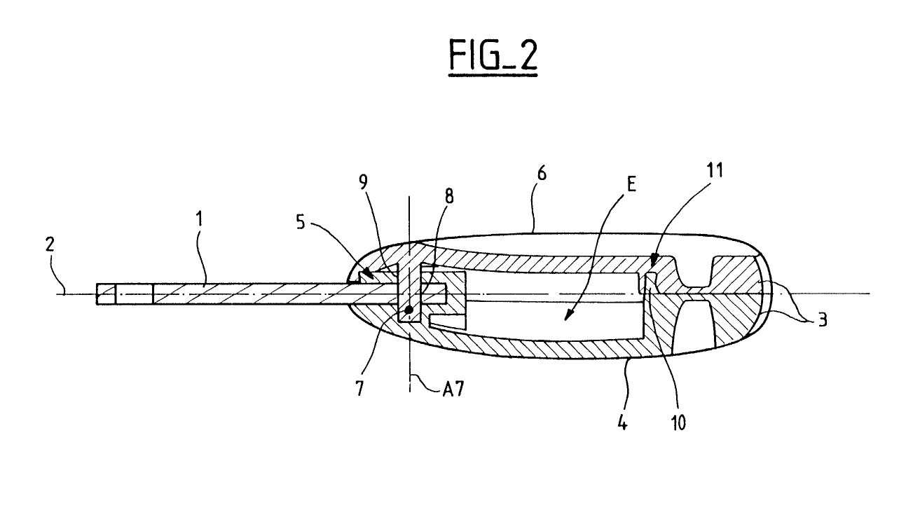

FIG. 2 is a sectional view of the assembled key.

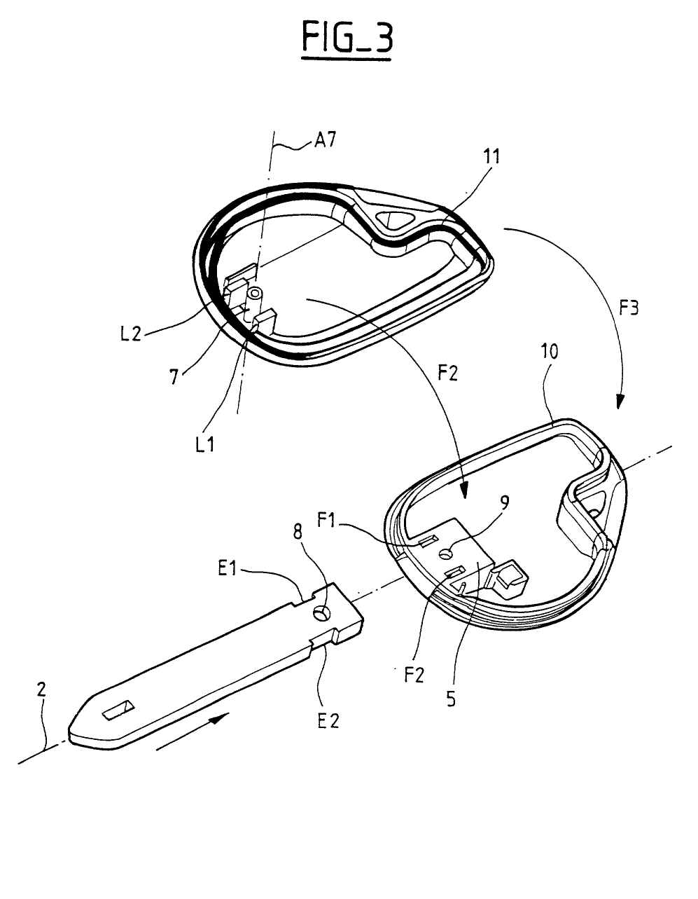

FIG. 3 is a perspective exploded view of elements forming the key.

FIG. 1 shows a perspective view of an assembled key that will mechanically activate a lock. This key comprises a metallic stem 1 with a longitudinal axis 2 and a plastic casing 3 rigidly connected to one end of the said stem. More particularly, the casing comprises an inner half casing 4 in the shape of a shell, inside which one end of the metallic stem is inserted at a link 5 free to slide along the longitudinal axis 2, and an upper half casing 6 also in the form of a shell that is rigidly connected to the lower half casing. The assembly thus formed is a rigid assembly of the plastic casing with the stem.

FIG. 2 is a sectional view of the assembled key along a plane comprising a longitudinal axis of the stem, showing a stem with a rectangular shaped section, one end of the rectangle being surrounded by the lower half casing 4 on one side and the upper half casing 6 on the other side. At the mechanical link between the end of the stem and the half casings, it can be seen that the shape of the housing 5 that forms an integral part of the half casing 4 is complementary to the shape of the lower end of the stem. Thus, in the sectional plane in the figure, the parallelepiped shape of the inside of the connecting housing is represented by a rectangle with one of its sides not shown, this side corresponding to the open face through which the end of the stem of the said parallelepiped is fitted. This figure also shows a post 7 with an axis perpendicular to the longitudinal axis that forms part of the upper half casing and that fits into a corresponding hole 8 at the end of the stem. Another hole 9 was formed in the upper face of the housing 5, to enable this post to pass through the corresponding hole near the end of the stem. There is an empty space E close to the housing inside the half casings, that will contain the electronic module for an infrared remote control that will be used for remote opening of a locking system.

This figure also shows a sectional view of the clipped assembly of the two half casings. This rigid assembly is composed of a “male” lip 10 forming part of the lower half casing, and that is inserted in a “female” duct 11 with a complementary shape forming part of the upper half casing.

FIG. 3 is a perspective view showing the three constituents of the key to be assembled, and shows a stem that is positioned in front of the housing 5 in a lower half casing, this lower half casing being adjacent to an upper half casing such that, when the stem is inserted into the housing 5 along the direction shown by arrow F1, and when the upper half casing is closed on the lower half casing as shown by arrows F2 and F3, the result is the assembled key as shown in FIG. 1. More particularly, FIG. 2 shows that the male lip 10 on the lower half casing extends around the entire periphery of the upper surface of the lower half casing. Similarly, the upper half casing has a duct 11 that extends around the periphery of the corresponding face of the upper half casing to hold the male lip 10 in order to form the clipped assembly of the half casings.

The view of the upper half casing more clearly shows that the section through the positioning post 7 is in the shape of a cross that will fit into a corresponding hole 8 at the end of the stem. The section is in the shape of a cross to facilitate the molding operation, to the extent that the thickness of the arms of the said cross is similar to the thickness of the casing itself, to avoid molding problems that would be caused by an overthickness of the post. Finally, this section in the shape of a cross facilitates positioning of the post with respect to the corresponding hole 8 at the end of the stem, to overcome problems related to geometric manufacturing dispersions.

Two rectangular shaped plates L1 and L2 can be seen close to the said positioning post, fitted in parallel to an axis of symmetry A7 of the positioning post 7 and the longitudinal axis 2. These plates will fit into corresponding recesses El and E2 at the end of the stem, and their purpose is to work in cooperation with the post in resisting tearout forces that the stem applies to the casing, particularly when the user pulls the key out of a lock.

In housing 5 in the lower half casing, it can be seen that the upper face of the said housing comprises a central hole into which the post on the upper half casing will be inserted, and two slots parallel to the longitudinal axis 2 that are positioned so that plates L1 and L2 will fit into them and so that they will be engaged in the corresponding recesses E1 and E2 in stem 1 to resist tearout forces.

1. A key intended to mechanically activate a lock comprising a metallic stem (1) with a longitudinal axis (2), and a plastic casing (3) rigidly connected to one end of the said stem, characterized in that the said casing includes a lower half casing (4) connected to the stem by a link (5) free to slide along the said longitudinal axis and an upper half casing (6) that is rigidly connected to the lower half casing and that comprises a post (7) perpendicular to the longitudinal axis that fits into a corresponding hole in the said stem to prevent any translation movement between the stem and the casing along the said longitudinal axis.

2. The key according to claim 1, in which the sliding link is composed of a housing (5) formed in the said lower half casing, the said housing being in the shape of a parallelepiped that will hold the end of the said stem that has a similar and complementary shape to the inside shape of the said housing, so that the only possible movement between the lower half casing and the stem is a translation movement along the longitudinal axis (2), the stem having a hole (9) on its upper face so that the post (7) fits into the corresponding hole (8) in the stem.

3. The key according to claim 1 or 2, in which the lower half casing and the upper half casing are assembled by clipping.

4. The key according to claim 1, 2 or 3, in which the section of the post (7) is in the shape of a cross.

5. The key according to claim 1, 2, 3 or 4, in which the upper half casing has two plates (L1, L2) parallel to an axis (A7) of the post (7) and parallel to the longitudinal axis (2), that are inserted into the corresponding recesses (E1, E2) on the sides of the stem.
